(19) United States
(12) Patent Application Publication
(10) Pub. No.: US 2001/0021652 A1
(43) Pub. Date: Sep. 13, 2001

(54) Data service communicaiton system and method for making data service therein

(75) Inventors: Hyo Sik Jeon, Kyonggi-do (KR); Chang Keun Seo, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 09/802,978

(22) Filed: Mar. 12, 2001

(30) Foreign Application Priority Data
Mar. 13, 2000 (KR) 2000-12518

(51) Int. Cl. H04Q 7/20; H04B 1/38

(52) U.S. Cl. 455/445; 455/560; 455/561

(57) ABSTRACT

Data service communication system, and method for making data service in the communication system are suggested. A particular service option is defined in advance for a fast data service between CDMA mobile stations belonging the same network. When an origination mobile station requests a call for the data service according to the particular service option, an MSC sets up a data traffic path between the origination mobile station and the destination mobile station according to the service request. A data is transmitted between the origination mobile station and the destination mobile station through the set up data traffic path. Accordingly, a load on the MSC is reduced and a fast data service can be made because the data service is made between the mobile stations within the same network without the IWF.

### BACKGROUND OF THE INVENTION

1. Field of the Invention

The present invention relates to a data service communication system, and a method for making a data service in the communication system.

2. Background of the Invention

In general, a reduction of communication system load and an enhancement of a data transmission rate between mobile stations are absolutely required when a data service is made between the mobile stations. Keeping pace with a sharp increase of demand for mobile stations, identical to the speech communication, necessity for a radio communication that requires securing a mobility of communication terminals is increasing even for the data communication. Traditionally, the radio data service has been used for a file transmission. Recently, other than the file transmission, there are information search at access to a computer, an Internet access, an industry computer access, and facsimile transmission and reception in the radio data service. In other words, the radio data service is, in a general term, inclusive of all services that can be implemented by radio among the services available from current PSTN (Public Switched Telephone Network) and PSDN (Public Switched Data Network). Therefore, the radio data service is inclusive of various applications, such as a report transmission from a site to a main office of information media, e-mail transmission and reception, a report transmission to a main office by an employee on outside duty, and the like. The radio service has been made available by adding an IWF (Inter-Working Function) to a lower structure of a current speech communication network. That is, the IWF made the radio data communication available. The mobile communication system includes elements each having an access function, such as a frame relay and X.25/PRI (Primary Rate Interface), for making access to other communication network. In other words, the mobile communication system provides users with data services, such as circuit data services and packet data services linked with other communication network, such as the PSTN, Internet, and PSPDN (Packet Switched Public Data Network). The standards for the radio data service includes IS-99, IS-707, IS-657, and IS-658, which are suggestions by the EIA (Electronic Industry Association)/TIA (Telecommunication Industry Association). According to the suggestions, the radio data service has operational functions, maintenance functions, and statistical functions separate from an MSC (Mobile Switching Center), operative independent from the MSC. FIG. 1 illustrates a diagram showing traffic paths used for carrying out data service in a related art mobile communication system.

Referring to FIG. 1, service options defined for providing the radio data service in a related art CDMA (Code Division Multiplication Access) mobile communication system includes a circuit data service option and a packet data service option.

First, the circuit data service option includes an 8K asynchronous data service (0×0004), an 8K G3 facsimile data service (0×0005), a 13K asynchronous data service (0×000C), a 13K G3 facsimile data service (0×000D), an 8K asynchronous renewal data service (0×1004), and a 13K G3 facsimile renewal data service (0×1005).

Second, the packet data service option includes a 13K PPP (Point to Point Protocol) packet data service (0×000F), a 13K CDPD (Cellular Digital Packet Data) packet data service (0×0010), an 8K PPP renewal packet data service (0×1007), an 8K CDPD renewal packet data service (0×1008), and a fast packet data bearer service (0×0016˜0—0019).

As described, for carrying out a data service by taking one of the defined service options, the mobile communication system is required to set up a call via the IWF 109 in FIG. 1 and a PDSN functional entity, and a data traffic path through the call. Such a related art method for carrying out a radio data service will be explained in detail with reference to a protocol stack in FIG. 2. FIG. 2 illustrates a protocol stack showing a related art method for carrying out a radio data service. As described, for carrying out a data service in a related art mobile communication service, the protocol stack in FIG. 2 is required to be observed, for which the IWF is required. That is, when there are mobile stations 101 and 103 requiring calls according to one of the data service options defined in the related art mobile communication system, the IWF 109 is known this fact. Then, a data traffic path is set up between the mobile stations 102 and 103 and the IWF 109. In detail, when the mobile station 102 in FIG. 1 requests a call according to the service option defined in advance for a data service, the mobile station 102 and a first base station 104 come into a traffic state. Then, as shown in FIG. 2, the mobile station 102 and the base station 104 set up a RLP (Radio Link Protocol), and set up a PPP protocol to the IWF 109 via the MSC 108. In this instance, as shown in FIG. 2, a relay layer is set up between an SDU (Service Data Unit) in the base station 104 and the MSC 108, and the MSC 108 and the IWF 109, respectively. An ISLP (Inter-System Link Protocol) of the IS-658 is used in a relay layer section. As described, according to the related art, the data service can be carried out between mobile stations in the same network, between stationary stations in the same network, and between a mobile station in a first network and a stationary station in a second network. All the foregoing data services are required to set up a data traffic path between the mobile or stationary station and the IWF, without fail.

The problems in the related art will be discussed.

First, since the IWF is invariably required even if a data service is carried out between mobile stations belonging to the same network, it is required in data service to proceed data division process in duplication in data transmission, which increases a load on the communication system.

Second, the invariable setting up of a traffic path via the IWF even in a case the data service is carried out between mobile stations within the same network requires much time in data transmission and reception.

### SUMMARY OF THE INVENTION

Accordingly, the present invention is directed to a data service communication system, and a method for making a data service in the communication system that substantially obviates one or more of the problems due to limitations and disadvantages of the related art.

An object of the present invention is to provide a data service communication system, and a method for making a data service in the communication system, which can reduce a system load when the data service is made between mobile stations within the same network.

Another object of the present invention is to provide a data service communication system, and a method for making a data service in the communication system, which can reduce data transmission and reception time periods when the data service is made between mobile stations within the same network.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a particular service option is defined in advance for a data service between mobile stations within the same network.

According to another aspect of the present invention, a speech traffic path is set up between an origination mobile station and a destination mobile station through the MSC by a VCE in a base station controller for carrying out the data service without the IWF within the same network.

According to further aspect of the present invention, the MSC switches the speech traffic path to the data traffic path in interlock with a BSP, a CCP, and an SBP in the base station controller.

According to the foregoing aspects of the present invention, when the origination mobile station request the data service according to the particular service option, the speech traffic path is set up between the origination mobile station and the MSC by a VCE in the base station controller. The MSC senses the particular service option and switches the speech traffic path to the destination mobile station. The data service is carried out between the origination mobile station and the destination mobile station through the set up speech traffic path.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a diagram showing a related art communication system and traffic paths for carrying out data service;

FIG. 2 illustrates a diagram showing a protocol stack of a related art communication system for carrying out a data service;

FIG. 3 illustrates a diagram showing a communication system and traffic paths for carrying out a data service in accordance with a first preferred embodiment of the present invention;

FIG. 4 illustrates a diagram showing a communication system and traffic paths for carrying out a data service in accordance with a second preferred embodiment of the present invention; and, FIG. 5 illustrates a diagram showing a process for carrying out a data service in a communication system of the present invention.

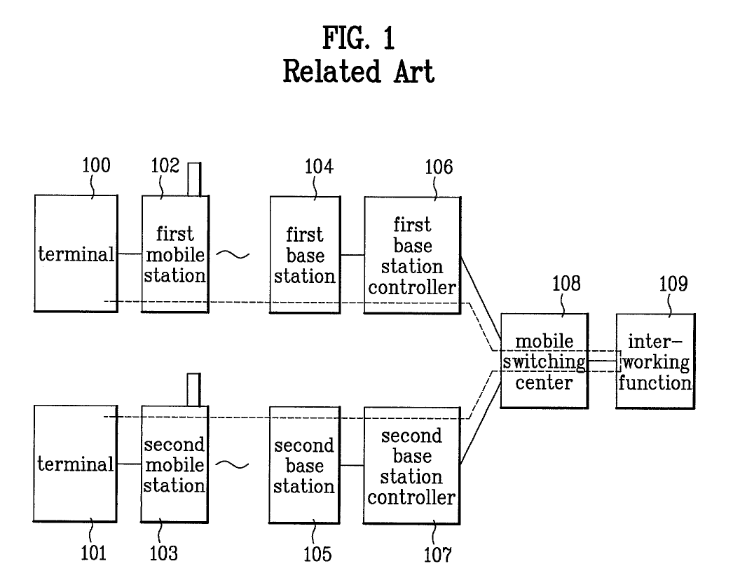

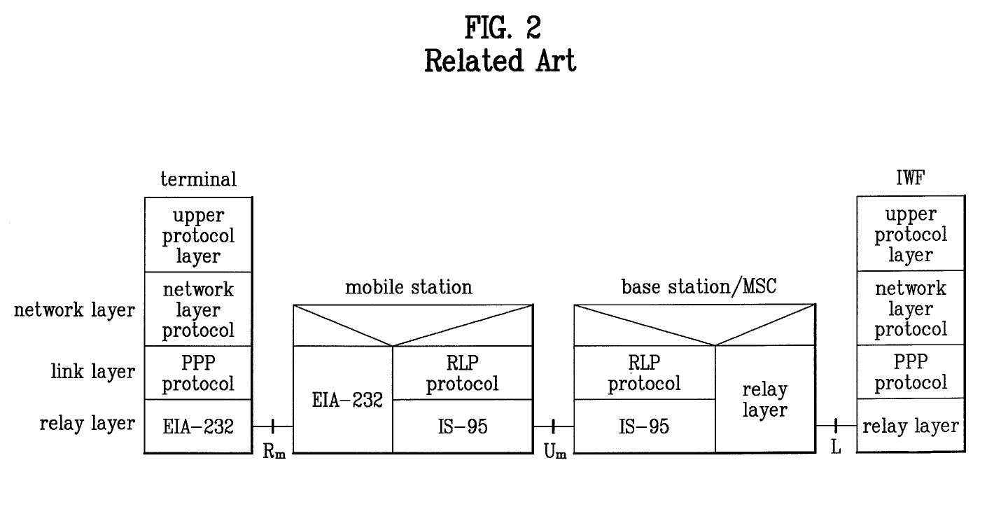

### DETAILED DESCRIPTION OF THE PREFERRED EMBODIMENT

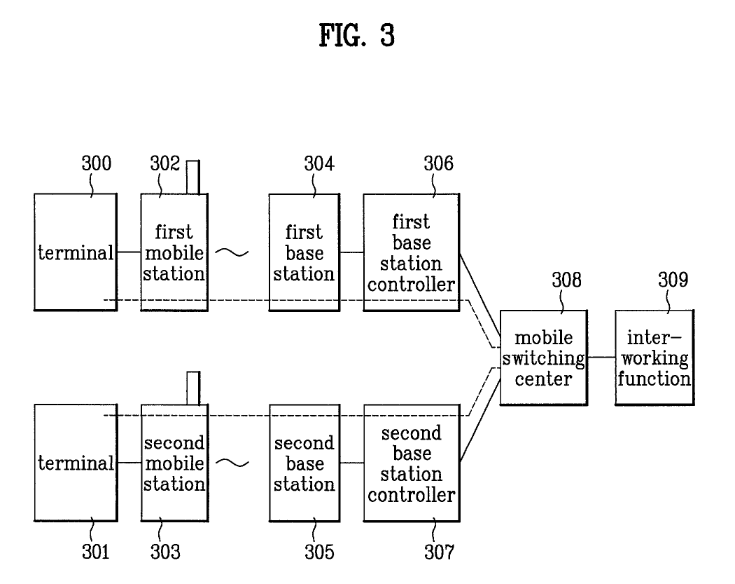

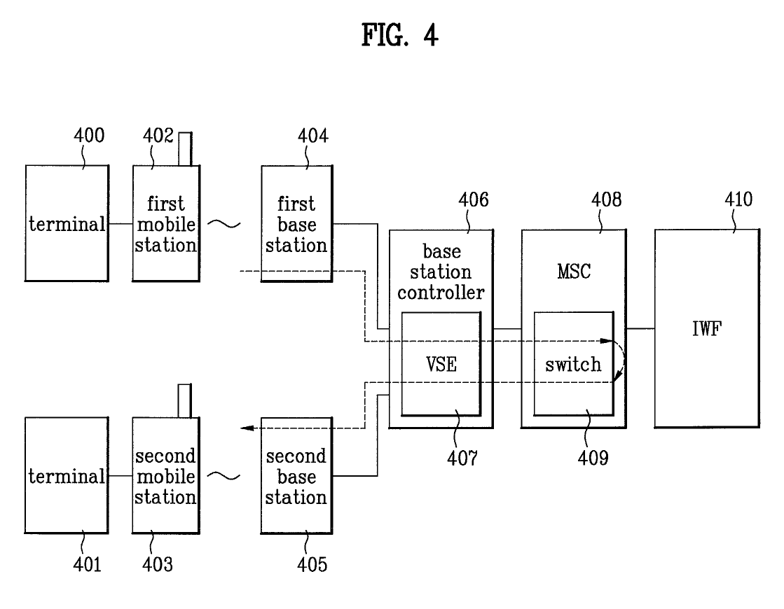

Reference will now be made in detail to the preferred embodiments of the present invention, examples of which are illustrated in the accompanying drawings. The present invention suggests no use of an IWF when a data service is made between mobile stations within the same network. Therefore, observation of a protocol stack related to a network in a currently defined protocol stack for a data service is not required. FIG. 3 illustrates a diagram showing a communication system and traffic paths for carrying out a data service in accordance with a first preferred embodiment of the present invention.

Referring to FIG. 3, in the communication system in FIG. 3, a first base station 304 to which a first mobile station 302, an origination side, belongs and a second base station 305 to which a second mobile station 303, a destination side, belongs use a first base station controller 306 and a second base station controller 307, respectively. In other words, the first base station 304 and the second base station 305 use base station controllers different from each other. In FIG. 3, the terminals 300 and 301 represent computers, to which the first mobile station 302 and the second mobile station 303 are connected respectively for data service. Meanwhile, a particular service option is defined in advance between the mobile stations 302 and 303 for carrying out the data service. For an example, when the first mobile station 302 requests the second mobile station 303, an origination side, for a call to request the data service according to a particular service option defined in advance, a system, i.e., an MSC 308 attempts to connect the call requested by the first mobile station 302, the origination side, to the second mobile station 303, not through an IWF 309, but directly. In this instance, the MSC 308 sets up a data traffic path between the first mobile station 302, the origination side, and the second mobile station 303, the destination side, in interlock with BSP (signaling processor of Base Transceiver Station), CCP (Call Control Processor), and SBP (Selector/Vocoder Bank Processor), sub-systems of the base station controller 306 for the first mobile station 302 and the base station controller 307 for the second mobile station 303. In this instance, the MSC 308 sets up the call such that a general speech traffic path is used as a data traffic path.

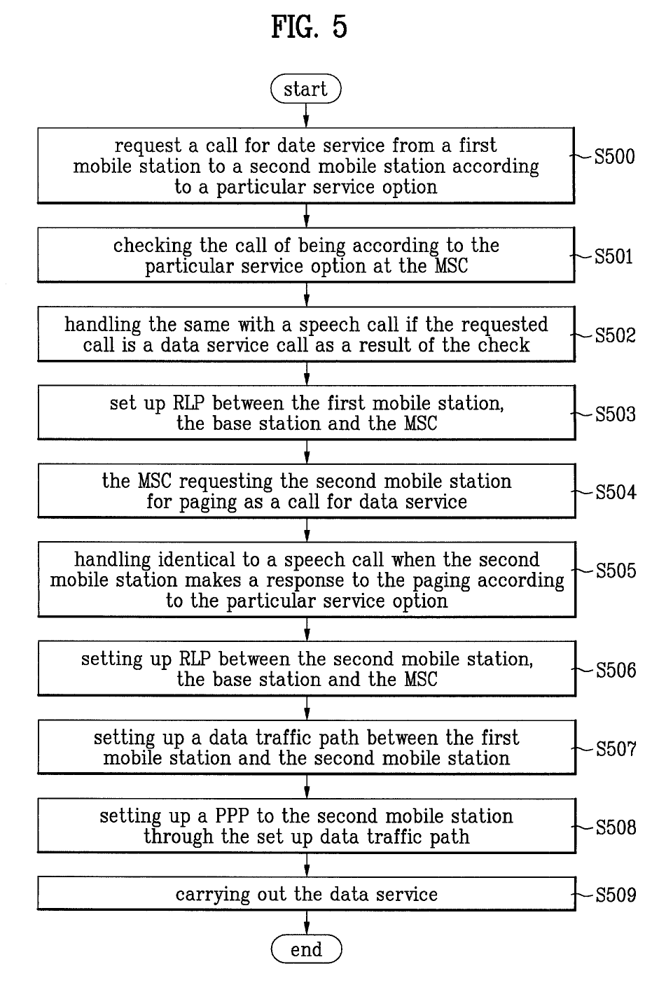

FIG. 4 illustrates a diagram showing a communication system and traffic paths for carrying out a data service in accordance with a second preferred embodiment of the present invention, wherein, different from the first preferred embodiment, base stations 404 and 405 use the same base station controller 406. The reference numerals 400 and 401 represent computers, the same as the first embodiment, connected to respective mobile stations, for making the data service.

When the first mobile station 403 request the second mobile station 403 for a call, an RLP (Radio Link Protocol) is set up between the first base station 404, the base station controller 406, the MSC 408, and the first mobile station 402. In other words, the RLP is set up between a VCE (Voice Channel Element) in the base station controller 406 and the first mobile station 402. Then, the MSC 408 informs the second mobile station that the call is requested by the first mobile station 402 by, upon sensing a particular service option defined in advance, switching a speech traffic path, not to an IWF, but to the second mobile station, a destination side mobile station, and paging the second mobile station. Upon reception of a response to the paging from the second mobile station according to the same particular service option, the MSC 408 connects the first mobile station 402 to the second mobile station 403 through the switched speech traffic path. The first mobile station 402 and the second mobile station 403 carries out the data service through the switched traffic service. As explained, according to particular service options defined in advance between mobile stations within the same network, the base stations carries out a data service function, and the MSC directly switches the general speech traffic path without passing through the IWF, to set up a data traffic path between the mobile stations. In other words, in the present invention, the IWF 410 serves nothing in carrying out the data service within the same network.

FIG. 5 illustrates a diagram showing a process for carrying out a data service in a communication system of the present invention.

Referring to FIG. 5, a first mobile station requests a second mobile station for a data service taking a particular service option defined in advance. (S500). The particular service option is an option for the data service defined in advance between the first and second mobile stations. Then, the MSC checks whether the call requested by the first mobile station is according to a particular service option. (S501). If the requested call is found to be the particular service option as a result of the check, the MSC does not transfers the requested call to the IWF, but handles in a fashion identical to a speech call even if the requested call is a call for a data service (S502), i.e., the MSC switches the speech traffic path to the second mobile station instead of the IWF. Then, when the first mobile station is in a traffic state, an SDU (Service Data Unit) in the base station and a VCE in the base station controller set up a RLP to the first mobile station (S503). Then, the MSC requests the second mobile station for a paging (S504). When the second mobile station makes a response to the paging according to the particular service option, even if the requested call is a call requesting for the data service, the MSC does not transfer the set up of the requested call to the IWF, but handles the requested call identical to a general speech call (S505). When the second mobile station is in a traffic state, the SDU in the base station and the VCE in the base station controller set up the RLP to the second mobile station (S506). When the second mobile station makes a response to the paging, the MSC switches the data traffic path from the first mobile station to the second mobile station, to set up the call for the data service (S507). Then, the first mobile station sets up a PPP to the second mobile station through the data traffic path set up between the first mobile station and the second mobile station (S508). Once set up of the PPP is completed, the data service can be made between the first mobile station and the second mobile station. That is, data transmission and reception between the mobile stations can be made (S509).

As has been explained, the data service communication system, and the method for making a data service in the communication system have the following advantages.

First, the IWF can be dispensed with when a data service is carried out between mobile stations within the same network, which prevents dividing a data in duplication, that reduces a load of the system, i.e., the MSC.

Second, the direct data transmission and reception without passing through the IWF when the data service is carried out between mobile stations in the same network permits a fast data service.

Third, no traffic path is required to be set up to the IWF when the data service is carried out between mobile stations in the same network, which allows an effective utilization of system resources. For an example, more system resource can be allocated to the mobile stations accessed, not to the same network, but to different networks, and requested services.

Fourth, a variety of data services are made available without the IWF within the same network.

It will be apparent to those skilled in the art that various modifications and variations can be made in the data service communication system, and the method for making a data service in the communication system of the present invention without departing from the spirit or scope of the invention. Thus, it is intended that the present invention cover the modifications and variations of this invention provided they come within the scope of the appended claims and their equivalents.

What is claimed is:

1. A method for making a data service in a communication system, comprising the steps of:
(1) defining a particular service option on data service between a first mobile station and a second mobile station within the same network;
(2) setting up a data traffic path between a base station controller, the first mobile station and the MSC (Mobile Switching Center) when the first mobile station requests the data service according the particular service option;
(3) checking the second mobile station making a response through the MSC according to the particular service option;
(4) setting up the data traffic path between the first mobile station and the second mobile station by using the MSC and the base station controller, when the second mobile station makes the response according to the particular service option; and,
(5) carrying out data service between the first mobile station and the second mobile station through the data traffic path.

2. A method as claimed in claim 1, wherein the MSC sets up the data traffic path between the first mobile station and the second mobile station in interlock with a BSP, a CCP, and an SBP in the base station controller.

3. A method for making a data service in a communication system, comprising the steps of:
(1) defining a particular service option on mutual data service between a first mobile station and a second mobile station within the same network;
(2) when the first mobile station requests a call for the data service, the MSC checking the call being requested according to the particular service option;
(3) when the call is requested according to the particular service option, setting up a RLP between the first mobile station, an origination side base station, and the MSC through a VCE in a base station controller;
(4) requesting a paging for the data service from the MSC to the second mobile station that is a destination side;
(5) when the second mobile station makes a response to the paging according to the particular service option, setting up a RLP between the second mobile station, the destination side base station, and the base station controller through the VCE;
(6) setting up a data traffic path between the first mobile station and the second mobile station by means of the MSC; and,
(7) carrying out the data service between the first mobile station and the second mobile station through the data traffic path.

4. A method as claimed in claim 3, wherein the base station controller includes one base station controller for controlling both the origination side base station and the destination side base station, or two base station controllers corresponding to the origination side base controller and the destination side base station controller.

5. A method as claimed in claim 3, wherein a PPP is set up between the origination side first mobile station, and the destination side second mobile station.

6. A communication system for data service, comprising:
an origination mobile station;
a destination mobile station within a network the same with the origination mobile station having a particular service option defined for the data service to the origination mobile station;
a base station controller for setting up a RLP between the origination mobile station, an MSC and the destination side base station through a VCE therein, when a call for the data service is requested according to the particular service option; and,
the MSC for setting up a data traffic path for data transmission between the destination mobile station and the origination mobile station through the origination base station when the data service is requested according to the particular service option.

7. A communication system as claimed in claim 6, wherein a PPP is set up between the origination mobile station and the destination mobile station by means of the MSC.

8. A communication system as claimed in claim 6, wherein the base station controller includes a first base station controller for the origination mobile station and a second base station controller for the destination mobile station.

9. A communication system as claimed in claim 6, wherein the base station controller includes one base station controller for controlling both the origination side base station and the destination side base station.

10. A communication system as claimed in claim 6, further comprising personal computers connected to the mobile stations as terminals for the data transmission in the data service.
